(19) United States
(12) Patent Application Publication
(10) Pub. No.: US 2007/0175346 A1
(43) Pub. Date: Aug. 2, 2007

(54) Reverse air flow web stabilizer

(75) Inventors: Kent Dirksen Kasper, Dover, NH (US); Drew Edwin Kiefaber, Newmarket, NH (US); Daniel Matthew Perdue, Rochester, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/345,801

(22) Filed: Feb. 2, 2006

(51) Int. Cl. B41F 5/04; B65H 20/14

(52) U.S. Cl. 101/219; 226/7; 226/97.3

(57) ABSTRACT

A web print unit includes a first plate cylinder, a first blanket cylinder for contacting the first plate cylinder, a second blanket cylinder, and a second plate cylinder for contacting the second blanket cylinder. A web to be printed passes between the first blanket cylinder and the second blanket cylinder at a blanket to blanket location, the first and second blanket cylinders are capable of being thrown apart. An air source is located on a side of the web and oriented to blow air upstream toward the blanket to blanket location while the blanket cylinders rotate.

### BACKGROUND

The present invention relates to printing presses and more particularly to a web stabilization apparatus.

In a web fed rotary printing press having multiple printing units, it may be desired to stop printing one or more printing units by throwing the blanket cylinders away from the web. This can permit, for example, a plate or blanket change. Automatic plate changes can occur using an automatic transfer printing unit. Such a printing press is, for example, manufactured by Goss International as the Sunday 2000 Autotransfer Press.

When the blanket cylinders are separated from the web, the web can pass freely between the two blanket cylinders. As the web passes between the separated blanket cylinders the web may demonstrate out-of-plane vibrations. More specifically, these out-of-plane vibrations can occur when the auto transfer unit blanket cylinders are rotating while off impression and when the web is passing through at normal printing speeds.

When the web experiences out-of-plane vibrations, unintentional web contact can occur with the blanket cylinders. Unintentional web contact with the blanket cylinders could result in print defects on the web or web breakage. It is known in the printing industry to use rollers located upstream and downstream from a printing unit in an attempt to stabilize a moving web. However, rollers can produce marking or damage to the web.

U.S. Pat. No. 5,924,619, hereby incorporated by reference herein, describes an apparatus for passing a printed web between separated cylinders of a deactivated printing unit, and uses blast air devices.

Referring to FIG. 1(a), a prior art printing press 100 is shown with a web 110 and without a web stabilization device. Printing press 100 has printing units 105-1 through 105-a, where a is a predetermined value, preferably 5 or 8 for an automatic transfer press with 5 units having two black printing units and 8 having two printing units each for magenta, cyan, yellow and black. The printing units 105-1 through 105-a each have 4 cylinders, 2 blanket cylinders, 2 plate cylinders and 2 automatic plate changers. Printing unit 105-1 has blanket cylinders 115-1a,b plate cylinders 120-1a,b, and automatic plate changers 160-1a,b. Print unit 105-2 has blanket cylinders 115-2a,b and plate cylinders 120-2a,b, where all 4 cylinders are rolling without contact, which can permit, for example, automatic plate transfer by automatic plate changers 160-a,b. As shown in FIG. 1(a), as web 110 moves in the direction denoted by arrow 125, web 110 experiences out-of-plane vibrations (denoted by arrow 130) where unintentional web contact can occur with blanket cylinders 115-2a,b.

FIG. 1(b) shows the prior art printing press 100 of FIG. 1(a) with rollers 130-a and 130-b located upstream and downstream from printing unit 105-2 which is off impression. Web 110 runs over roller 130-a and under 130-b in an attempt to provide out-of-plane web stability. The problem with this configuration is that rollers 130-a,b can produce unacceptable damage to web 110, such as marking or damage.

FIG. 1(c) shows the prior art printing press 100 of FIG. 1(a) with rollers 140-a and 140-b located upstream and downstream from the deactivated printing unit 105-2, in an attempt to provide out-of-plane web stability. In FIG. 1(c), the cylinders of print unit 105-2 are inclined away from the vertical angle by an angle of inclination, for example, of 10 to 15 degrees. Like in FIG. 1(b), web 110 runs over roller 145-a and under roller 145-b in an attempt to stabilize moving web 110. As mentioned above, rollers 140-a,b can produce unacceptable damage to web 110, such as damage to the wet printed surface and web breakage.

### SUMMARY OF THE INVENTION

The present invention provides a web print unit including a first plate cylinder, a first blanket cylinder for contacting the first plate cylinder, a second blanket cylinder, and a second plate cylinder for contacting the second blanket cylinder. A web to be printed passes between the first blanket cylinder and the second blanket cylinder at a blanket to blanket location, the first and second blanket cylinders are capable of being thrown apart and rotating while apart. An air source is located on a side of the web and oriented to blow air upstream toward the blanket to blanket location when the cylinders are apart and rotating.

### BRIEF DESCRIPTION OF THE DRAWINGS

Further objects, features and advantages of the invention will become apparent from the following detailed description taken in conjunction with the accompanying drawings, in which:

FIG. 1(a), illustrates a prior art automatic transfer printing press having multiple printing units without stabilizing a web;

FIGS. 1(b) and 1(c) illustrate prior art rollers for stabilizing a web in an automatic transfer unit;

FIG. 2 illustrates a printing press with noncontact stabilizers in accordance with an embodiment of the present invention;

FIG. 3 illustrates an embodiment of a blower in accordance with an embodiment of the present invention.

FIG. 4 illustrates an embodiment of a blower in accordance with an embodiment of the present invention.

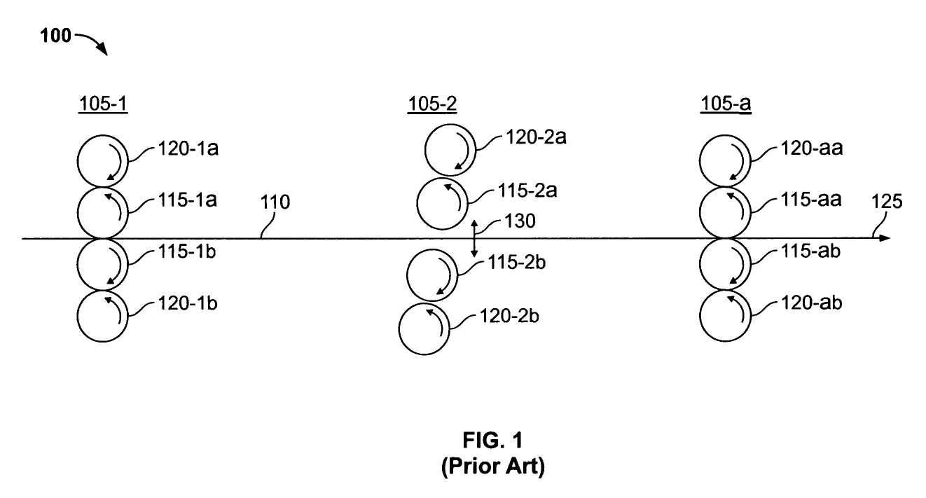

### DETAILED DESCRIPTION

In accordance with the embodiments of the present invention, one or more blowers blow air in an upstream direction at the blanket to blanket nip exit in the vicinity of a web, which can reduce flutter and stabilize the web while the blanket cylinders are rotating.

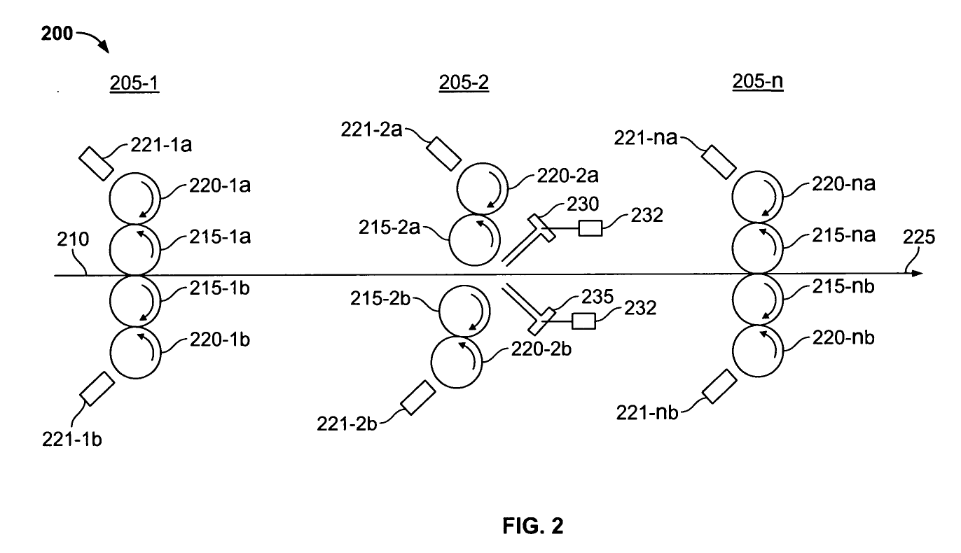

FIG. 2 illustrates a printing press of the present invention with blowers 230 and 235 for improving out-of-plane web stability of moving web 210. As shown in FIG. 2, a printing press 200 has print units 205-1 through 205-n, where n is a predetermined value. Each print unit 205-1 through 205-n is shown with 4 cylinders: blanket cylinders 215-1a,b through 215-na,b, plate cylinders 220-1a,b through 220-na,b, and automatic plate change units 221-1a,b through 221-na,b.

As shown in FIG. 2, print units 205-1 and 205-n have all four cylinders rolling and blanket cylinders 215-1a,b and 215-na,b in contact with web 210. In contrast, print unit 205-2 has blanket cylinders 215-2a,b and plate cylinders 220-2a,b rolling without contact with web 210. Web 210 moves from print unit 205-1 to print unit 205-n in the direction denoted by arrow 225. Web 210 passes between print unit 205-1 and between print unit 205-2 before passing between blowers 230 and 235.

In accordance with an embodiment of the present invention, blowers 230 and 235 are positioned on the exit side of the blanket to blanket nip. Blowers 230 and 235 are oriented to blow air upstream toward the blanket to blanket location, thus decreasing out-of-plane vibrations of web 210. The destabilizing forces causing web 210 to vibrate out-of-plane are disrupted by the air flow from blowers 230 and 235, which cause web 210 to return to its nominal running position. Further, in accordance with an embodiment of the present invention, a single blower, for example blower 235, can be used to stabilize web 210.

Blowers 230 and 235 are moveable by actuators 232 so that the distance and angle between web 210 and blowers 230 and 235 can be adjusted. As mentioned above, the air flows created by blowers 230 and 235 prevent out-of-plane vibrations of web 210 and stabilize web 210 as it exits print unit 205-2.

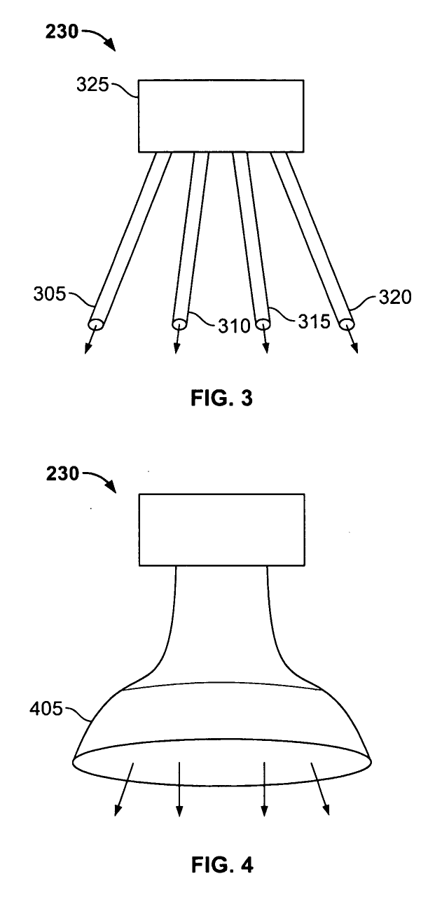

Various embodiments of blowers 230 and 235 in accordance with the present invention are shown in FIGS. 3 and 4. FIG. 3 shows an embodiment where blower 230 has a manifold 325 with 4 air outputs 305 through 320. FIG. 4 shows another embodiment where blower 230 includes a single nozzle 405 with an opening elongated in the web width direction for directing the air output towards the blanket to blanket exit nip. The blowers 230 and 235 can be incorporated into existing structures within the printing press.

The desired volume flow of air can be determined for example by experiment at certain speeds, and can be varied as a function of web speed. During stabilization the plates can be automatically changed. The number of print units preferably is 5 or more, but can be any number.

As opposed to separate blowers, air from any source, such as compressed air available from a compressor in the printing press plant, may be used. For example, compressed air at 90 psi could be connected to a regulator to set nozzle pressure at 10 to 15 psi. Each side of the web may have a regulator, and the pressure or nozzle locations and orientations varied to center or bias the web to a specific location within the blanket-to-blanket gap. For example, the pressure on one side can be lowered or set to zero to move the web in that direction. The pressure or nozzle locations and orientations also could be varied as a function of blanket cylinder speed.

Preferably no air is blown from the upstream side into the blanket-to-blanket gap.

1: A web print unit comprising:
a first plate cylinder;
a first blanket cylinder for contacting the first plate cylinder;
a second blanket cylinder;
a second plate cylinder for contacting the second blanket cylinder, a web to be printed passing between the first blanket cylinder and the second blanket cylinder at a blanket to blanket location, the first and second blanket cylinders capable of being thrown apart and rotating while thrown apart; and
a first air source located on a first side of the web and oriented to blow air upstream toward the blanket to blanket location during rotation of the first and second blanket cylinders when thrown apart.

2: The print unit as recited in claim 1 further comprising a second air source located on a second side of the web oriented to blow air upstream toward the blanket to blanket location.

3: The print unit as recited in claim 1 further comprising a first actuator connected to the first air source for changing an angle of the first air source and/or for moving the first air source upstream or downstream.

4: The print unit as recited in claim 1 further comprising an automatic plate changer for changing plates on the first plate cylinder and the second plate cylinder.

5: The print unit as recited in claim 1 wherein the first air source comprises a manifold and two or more air outputs.

6: The print unit as recited in claim 2 wherein the second air source comprises a manifold and two or more air outputs.

7: The print unit as recited in claim 1 wherein the first air source comprises a single output elongated in a web width direction.

8: The print unit as recited in claim 2 wherein the second air source comprises a single output elongated in a web width direction.

9: A method for stabilizing a web to be printed comprising:
passing a web between a first blanket cylinder and a second blanket cylinder at a blanket to blanket location;
separating the first blanket cylinder and the second blanket cylinder from the web;
blowing air on one side of the web upstream towards the blanket to blanket location while the first and second blanket cylinders are separated and rotating.

10: The method recited in claim 9 further comprising blowing air on a second side of the web upstream towards the blanket to blanket location.

11: The method recited in claim 9 further comprising changing an angle of the blowing air on one side of the web.

12: The method recited in claim 10 further comprising changing an angle of the blowing air on the second side of the web.

13: The method recited in claim 9 further comprising automatically removing a plate from the first plate cylinder during the blowing step.

14: The method as recited in claim 9 wherein no air is blown in a direction of travel of the web downstream from upstream of the blanket to blanket location.

15: The method as recited in claim 9 further comprising positioning the web in the blanket to blanket location as a function of the blowing.

16: A print press comprising the web print unit recited in claim 1.
